(19) United States
(12) Patent Application Publication
(10) Pub. No.: US 2026/0331368 A1
(43) Pub. Date: Oct. 22, 2026

(54) MULTILAYER CERAMIC CAPACITOR

(71) Applicant: Murata Manufacturing Co., Ltd., Nagaokakyo-shi (JP)

(72) Inventor: Takefumi TAKAHASHI, Nagaokakyo-shi (JP)

(21) Appl. No.: 19/648,067

(22) Filed: Apr. 15, 2026

(30) Foreign Application Priority Data
Apr. 22, 2025 (JP) 2025-070789

(51) Int. Cl. H01G 4/008; H01G 4/30

(52) U.S. Cl. CPC H01G 4/0085; H01G 4/30

(57) ABSTRACT

A multilayer ceramic capacitor include a multilayer body including dielectric layers and inner electrodes laminated in a lamination direction, first and second main surfaces facing each other in the lamination direction, third and fourth surfaces facing each other in a first direction, fifth and sixth surfaces facing each other in a second direction, and first and second underlying electrodes on a surface of the multilayer body. The first underlying electrode is on the third surface, the inner electrode connected to the first underlying electrode includes a protrusion that protrudes into the dielectric layer on a surface where the inner electrodes face each other across the dielectric layer, and the protrusion includes a metal component included in the first underlying electrode.

### CROSS REFERENCE TO RELATED APPLICATIONS

This application claims the benefit of priority to Japanese Patent Application No. 2025-070789 filed on Apr. 22, 2025. The entire contents of this application are hereby incorporated herein by reference.

### BACKGROUND OF THE INVENTION

### 1. Field of the Invention

The present invention relates to multilayer ceramic capacitors.

### 2. Description of the Related Art

A multilayer ceramic capacitor generally includes an inner electrode including Ni inside a multilayer body, and an outer electrode including Cu on the surface of the multilayer body for connecting to the inner electrode.

The outer electrode is formed by applying and baking a conductive paste onto the surface of the multilayer body where one end of the inner electrode is exposed. During the baking process, Ni in the inner electrode and Cu in the outer electrode diffuse and fuse into each other, electrically connecting the inner electrode and the outer electrode (see, for example, Japanese

### SUMMARY OF THE INVENTION

However, too much Cu in the outer electrode diffusing into the multilayer body increases stress in a lamination direction in the multilayer body, causing cracks in the multilayer body.

Accordingly, example embodiments of the present invention provide multilayer ceramic capacitors that each reduce or prevent generation of cracks in a multilayer body even if metal components included in an outer electrode diffuse into the multilayer body.

The inventor of the present invention has discovered that the generation of cracks in the multilayer body can be reduced or prevented by providing a protrusion in a portion of the inner electrode, the protrusion including a metal component included in an underlying electrode of the outer electrode, leading to the completion of example embodiments of the present invention.

According to an example embodiment of the present invention, a multilayer ceramic capacitor includes a multilayer body including a plurality of dielectric layers and a plurality of inner electrodes laminated in a lamination direction, and including a first main surface and a second main surface facing each other in the lamination direction, a third surface and a fourth surface facing each other in a first direction intersecting with the lamination direction, and a fifth surface and a sixth surface facing each other in a second direction intersecting with the lamination direction and the first direction, and a first underlying electrode and a second underlying electrode on a surface of the multilayer body, in which the first underlying electrode is on the third surface, the inner electrode connected to the first underlying electrode includes a protrusion that protrudes into the dielectric layer on a surface where the inner electrodes face each other across the dielectric layer, and the protrusion includes a metal component included in the first underlying electrode.

Example embodiments of the present invention provide multilayer ceramic capacitors that each reduce or prevent generation of cracks in a multilayer body even if metal components included in an outer electrode diffuse into the multilayer body.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view showing a multilayer ceramic capacitor according to an example embodiment of the present invention.

FIG. 2 is a cross-sectional view (LT cross-section) taken along line II-II of the multilayer ceramic capacitor 1 shown in FIG. 1.

FIG. 3 is a cross-sectional view (WT cross-section) taken along line III-III of the multilayer ceramic capacitor 1 shown in FIG. 1.

FIG. 4 is a cross-sectional view (LW cross-section) taken along line IV-IV of the multilayer ceramic capacitor 1 shown in FIG. 3.

FIG. 5 is an enlarged cross-sectional view (LT cross-section) of an extended portion of a first inner electrode.

FIG. 6A is an enlarged cross-sectional view of a protrusion according to a first example embodiment of the present invention.

FIG. 6B is an enlarged cross-sectional view of a protrusion according to a second example embodiment of the present invention.

FIG. 6C is an enlarged cross-sectional view of a protrusion according to a third example embodiment of the present invention.

FIG. 6D is an enlarged cross-sectional view of a protrusion according to a fourth example embodiment of the present invention.

FIG. 7A is a diagram showing distribution of Ni in a first underlying electrode and the extended portion of the first inner electrode.

FIG. 7B is a diagram showing distribution of Cu in the first underlying electrode and the extended portion of the first inner electrode.

FIG. 7C is a diagram showing distribution of Cu and Ni in the first underlying electrode and the extended portion of the first inner electrode.

FIG. 8 is a diagram showing an enlarged cross-section (LT cross-section) of the extended portion of the first inner electrode and the distribution of Cu and Ni.

FIGS. 9A and 9B are diagrams showing two inner electrode patterns formed on a dielectric sheet.

FIGS. 10A-10D are diagrams explaining a manufacturing process of the multilayer ceramic capacitor 1.

### DETAILED DESCRIPTION OF THE EXAMPLE EMBODIMENTS

Example embodiments of multilayer ceramic capacitors of the present invention will be described below, but the present invention is not limited thereto. The drawings may be simplified and schematic in order to explain example embodiments of the present invention, and the dimensional ratios of the depicted components or between the components do not sometimes match those described in the specification. The components described in the specification may also be omitted in the drawings, or may be depicted in smaller numbers.

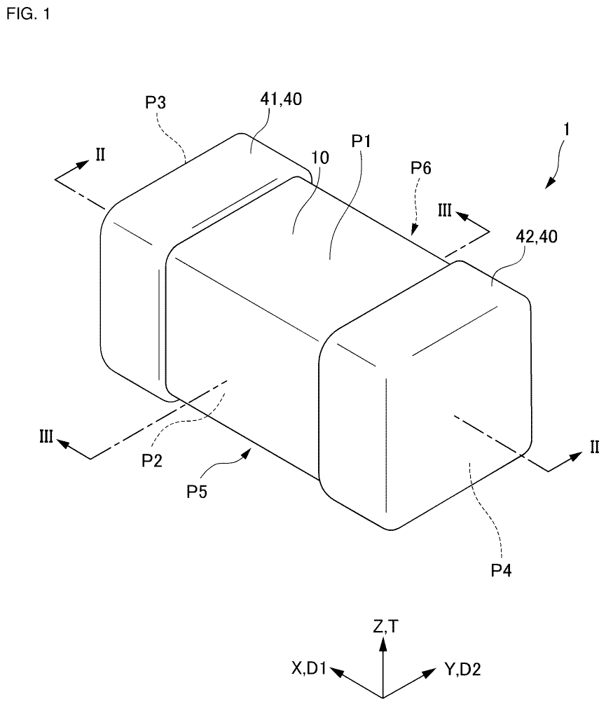

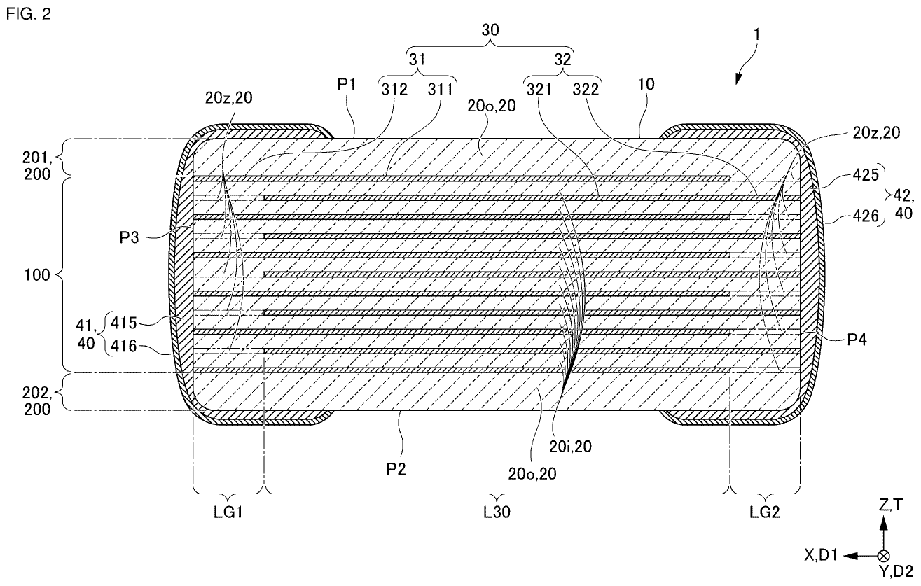

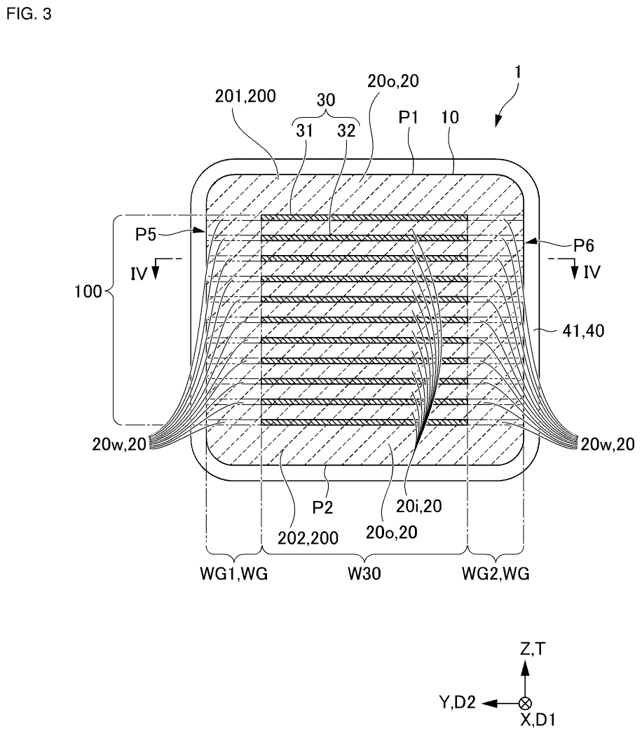

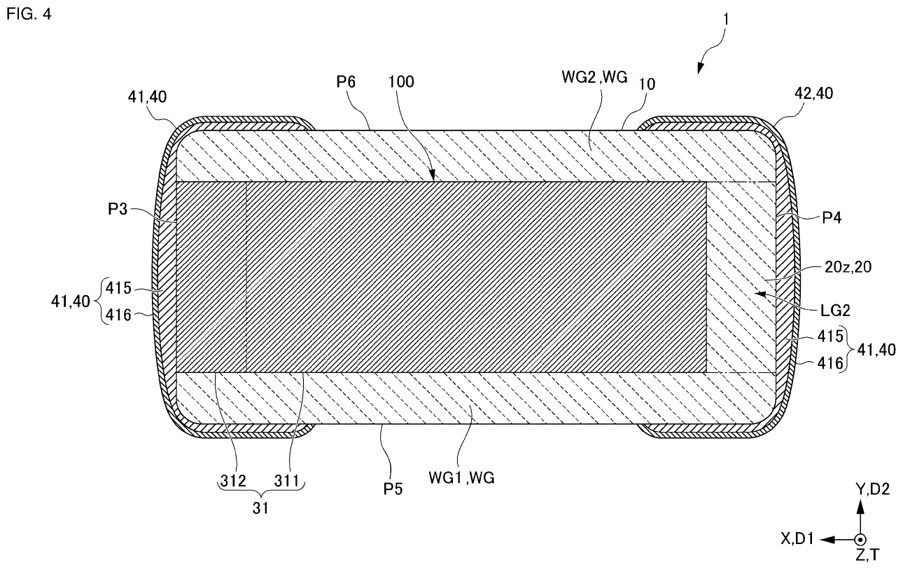

FIG. 1 is a perspective view showing a multilayer ceramic capacitor. FIG. 2 is a cross-sectional view taken along line II-II of the multilayer ceramic capacitor shown in FIG. 1. FIG. 3 is a cross-sectional view taken along line III-III of the multilayer ceramic capacitor shown in FIG. 1. FIG. 4 is a cross-sectional view taken along line IV-IV in FIG. 3. A multilayer ceramic capacitor 1 shown in FIGS. 1 to 4 includes a multilayer body 10 and an outer electrode 40. The outer electrode 40 includes a first outer electrode 41 and a second outer electrode 42.

FIGS. 1 to 4 show an XYZ Cartesian coordinate system. An X direction is a first direction D1 of the multilayer ceramic capacitor 1 and the multilayer body 10. A Y direction is a second direction D2 of the multilayer ceramic capacitor 1 and the multilayer body 10. A Z direction is a lamination direction T of the multilayer ceramic capacitor 1 and the multilayer body 10. The cross-section shown in FIG. 2 is also referred to as an LT cross-section. The cross-section shown in FIG. 3 is also referred to as a WT cross-section. The cross-section shown in FIG. 4 is also referred to as an LW cross-section.

Note that the first direction D1, the second direction D2, and the lamination direction T are not necessarily orthogonal to each other, and may intersect with each other.

The multilayer ceramic capacitor shown as an example embodiment has a dimension in the first direction D1 of about 0.10 mm to about 0.16 mm, a dimension in the second direction D2 of about 0.05 mm to about 0.10 mm, and a dimension in the lamination direction T of about 0.05 mm to about 0.10 mm, or has the dimension in the first direction D1 of about 0.20 mm to about 5.20 mm, the dimension in the second direction D2 of about 0.10 mm to about 5.00 mm, and the dimension in the lamination direction T of about 0.10 mm to about 2.50 mm, for example. However, the dimensions of the multilayer ceramic capacitor are not particularly limited to those described above.

The multilayer body 10 has a substantially rectangular parallelepiped shape and includes a first surface P1 and a second surface P2 facing each other in the lamination direction T, a fifth surface P5 and a sixth surface P6 facing each other in the second direction D2, and a third surface P3 and a fourth surface P4 facing each other in the first direction D1. These surfaces may have unevenness or be roughened.

The ridges and corners of the multilayer body 10 are preferably rounded. The ridge is where two surfaces of the multilayer body 10 intersect, while the corner is where three surfaces of the multilayer body 10 intersect.

The multilayer body 10 includes an inner layer portion 100 that generates an electrostatic capacitance, outer layer portions 200 on both sides of the inner layer portion 100 in the lamination direction T, and side margin portions WG on both sides of the inner layer portion 100 in the second direction D2.

The inner layer portion 100 includes a plurality of inner dielectric layers 20i and a plurality of inner electrodes 30. The inner layer portion 100 is a region formed by laminating the plurality of inner dielectric layers 20i and inner electrodes 30, and sandwiched between the inner electrodes 30 located on both ends in the lamination direction T. In the inner layer portion 100, the plurality of inner electrodes 30 are disposed facing each other with the inner dielectric layers 20i interposed therebetween, defining electrode facing portions L30 and W30 that generate the electrostatic capacitance. The inner layer portion 100 is a portion that essentially functions as a capacitor.

A first outer layer portion 201 is on the first surface P1 side of the multilayer body 10, and a second outer layer portion 202 is on the second surface P2 side of the multilayer body 10. More specifically, the first outer layer portion 201 is disposed between the first surface P1 and the inner electrode 30 closest to the first surface P1 among the plurality of inner electrodes 30. The second outer layer portion 202 is disposed between the second surface P2 and the inner electrode 30 closest to the second surface P2 among the plurality of inner electrodes 30. The first outer layer portion 201 and the second outer layer portion 202 are formed of dielectric layers 20o and do not include the inner electrodes 30. The first outer layer portion 201 and the second outer layer portion 202 may be provided with dummy electrodes that do not face each other in the lamination direction T.

It is preferable to use the same dielectric material for the inner dielectric layers 20i and the dielectric layers 20o among the dielectric layers 20 of the multilayer body 10. The inner dielectric layers 20i and the dielectric layers 20o may differ from each other in amount of additives included therein.

The material for the dielectric layer 20 may be a dielectric ceramic including, for example, BaTiO₃, CaTiO₃, SrTiO₃, CaZrO₃ or the like as its main component. For example, an Mn compound, Ni compound, Fe compound, Cr compound, Co compound, Mg compound, Si compound, Al compound, V compound, rare earth compound or the like may be added as an accessory component to the material for the dielectric layer 20.

The thickness of the dielectric layer 20 is not particularly limited, but is preferably about 0.3 μm to about 5.0 μm, and more preferably about 0.3 μm to about 2.0 μm, for example. The number of the dielectric layers 20 is not particularly limited, but is preferably 100 to 2000, for example. Note that the number of the dielectric layers 20 is the sum of the number of the inner dielectric layers 20i in the inner layer portion 100 and the number of the dielectric layers 20o in the outer layer portion 200.

The plurality of inner electrodes 30 include a first inner electrode 31 and a second inner electrode 32.

The first inner electrode 31 includes a facing portion 311 and an extended portion 312. The second inner electrode 32 includes a facing portion 321 and an extended portion 322.

The facing portion 311 of the first inner electrode 31 and the facing portion 321 of the second inner electrode 32 face each other across the inner dielectric layer 20i in the lamination direction T of the multilayer body 10. The shape of the facing portions 311 and 321 is not particularly limited and may be, for example, a substantially rectangular shape. The facing portions 311 and 321 are portions that generate an electrostatic capacitance and essentially function as the capacitor.

The extended portion 312 of the first inner electrode 31 is extended from the facing portion 311 toward the third surface P3 of the multilayer body 10, and is exposed at the third surface P3. The extended portion 322 of the second inner electrode 32 is extended from the facing portion 321 toward the fourth surface P4 of the multilayer body 10, and is exposed at the fourth surface P4.

The first inner electrode 31 is thus connected to the first outer electrode 41, and spacing is provided between the first inner electrode 31 and the fourth surface P4 of the multilayer body 10, that is, the second outer electrode 42. The second inner electrode 32 is connected to the second outer electrode 42, and spacing is provided between the second inner electrode 32 and the third surface P3 of the multilayer body 10, that is, the first outer electrode 41.

The shape of the extended portion 312 of the first inner electrode 31 may be tapered so that its width in the second direction D2 gradually narrows toward the third surface P3. The shape of the extended portion 322 of the second inner electrode 32 may be tapered so that its width in the second direction D2 gradually narrows toward the fourth surface P4.

The first inner electrode 31 and the second inner electrode 32 may mainly include at least one type of metal, such as Ni, Cu, Ag, Pd, or Au, or an Ag—Pd alloy, and may also include metal such as Sn and In as a component other than the above main component. Sn, In or Au may define a layer on the surface of the inner electrode. Such a layer may be provided on the surface of either the first inner electrode 31 or the second inner electrode 32. This makes it possible to improve insulation resistance between inner electrodes of different potentials.

Furthermore, the first inner electrode 31 and the second inner electrode 32 may also include, as a component other than the above main component, dielectric particles having the same composition as the ceramic included in the inner dielectric layer 20i. Note that the term “main metal component” refers herein to a metal component with the highest % by weight.

The thickness of the inner electrode 30 is not particularly limited, but is preferably about 0.30 μm to about 0.80 μm, and more preferably about 0.30 μm to about 0.60 μm, for example. The number of the inner electrodes 30 is not particularly limited, but is preferably 10 to 1000, for example.

The side margin portions WG are disposed so as to sandwich the inner layer portion 100 from both sides in the second direction D2. The side margin portions WG include a first side margin portion WG1 that forms the fifth surface P5 of the multilayer ceramic capacitor 1 and a second side margin portion WG2 that defines the sixth surface P6 of the multilayer ceramic capacitor 1. The side margin portions WG can be formed of the same material as the dielectric layer 20.

The first side margin portion WG1 and the second side margin portion WG2 are also referred to as side gaps or W gaps.

Note that the first side margin portion WG1 and the second side margin portion WG2 will be collectively referred to as the side margin portions WG, when there is no need to particularly distinguish therebetween.

The side margin portions WG do not include the inner electrode 30. This causes steps at both ends of the inner electrode 30 in the second direction D2. To eliminate these steps, dielectric layers 20w having a thickness equivalent to that of the inner electrode 30 can be disposed.

The dielectric layers 20w do not necessarily have to be provided. The multilayer body 10 may be formed without the dielectric layers 20w.

As shown in FIG. 2, the multilayer body 10 includes, in the first direction D1, an electrode facing portion L30 where the first inner electrode 31 and second inner electrode 32 of the inner electrode 30 face each other, a first end margin portion LG1, and a second end margin portion LG2. The first end margin portion LG1 is located between the electrode facing portion L30 and the third surface P3. The second end margin portion LG2 is located between the electrode facing portion L30 and the fourth surface P4. More specifically, the first end margin portion LG1 is located between the third end surface P3 and the end of the second inner electrode 32 on the third surface P3 side. The second end margin portion LG2 is located between the fourth surface P4 and the end of the first inner electrode 31 on the fourth surface P4 side.

The first end margin portion LG1 includes the first inner electrode 31 and the dielectric layer 20, but does not include the second inner electrode 32. This allows a dielectric layer 20z having a thickness equivalent to that of the second inner electrode 32 to be provided, eliminating a step at the end of the second inner electrode 32 on the third surface P3 side. The second end margin portion LG2 includes the second inner electrode 32 and the dielectric layer 20, but does not include the first inner electrode 31. This allows a dielectric layer 20z having a thickness equivalent to that of the first inner electrode 31 to be provided, eliminating a step at the end of the first inner electrode 31 on the fourth surface P4 side.

The dielectric layers 20z do not necessarily have to be provided. The multilayer body 10 may be formed without the dielectric layers 20z.

The outer electrode 40 includes the first outer electrode 41 and the second outer electrode 42.

The first outer electrode 41 is on the third surface P3 of the multilayer body 10 and is connected to the first inner electrode 31. The first outer electrode 41 may extend from the third surface P3 to a portion of the first surface P1 and a portion of the second surface P2. The first outer electrode 41 may also extend from the third surface P3 to a portion of the fifth surface P5 and a portion of the sixth surface P6.

The second outer electrode 42 is on the fourth surface P4 of the multilayer body 10 and is connected to the second inner electrode 32. The second outer electrode 42 may extend from the fourth surface P4 to a portion of the first surface P1 and a portion of the second surface P2. The second outer electrode 42 may also extend from the fourth surface P4 to a portion of the fifth surface P5 and a portion of the sixth surface P6.

The first outer electrode 41 may include a first underlying electrode 415 and a first plating layer 416 on the first underlying electrode 415. The second outer electrode 42 may include a second underlying electrode 425 and a second plating layer 426 on the second underlying electrode 425.

The first underlying electrode 415 and the second underlying electrode 425 are baked layers.

The baked layer is formed by applying and baking a conductive paste including a glass component and metal to the multilayer body 10. The baking may be carried out after firing of the inner electrodes 30. The baking temperature is preferably about 700 to about 900 °C, for example.

The glass component includes at least one of B, Si, Ba, Mg, Al, or Li, or the like. The metal includes at least one of Cu, Ni, Ag, Pd, Ag—Pd alloy, or Au, or the like, for example.

The baked layer preferably has a thickness of, for example, about 0.1 μm to about 200 μm. The baked layer may include a plurality of layers.

A conductive resin layer may be formed on the surface of the baked layer. The conductive resin layer may include a plurality of layers.

The conductive resin layer is formed by applying a conductive resin paste including thermosetting resin and metal components to the baked layer and then performing heat treatment at a temperature of, for example, about 250 to about 550 °C to thermally cure the resin and thus form the conductive resin layer. The heat treatment is preferably performed in an N2 atmosphere. To reduce or prevent scattering of the resin and the oxidation of the various metal components, the oxygen concentration is preferably kept less than or equal to about 100 ppm, for example.

The conductive resin layer preferably has a thickness of, for example, about 10 μm to about 200 μm at the center of the third surface P3 and the fourth surface P4. The conductive resin layer on the first surface P1 and the second surface P2 as well as on the fifth surface P5 and the sixth surface P6 preferably has a thickness of, for example, about 5 μm to about 50 μm at the center in the first direction D1.

The resin for the conductive resin layer can be any of a variety of well-known thermosetting resins, such as epoxy resin, phenolic resin, urethane resin, silicone resin, and polyimide resin, for example. Among these, epoxy resin is one of the most suitable resins because of its excellent heat resistance, moisture resistance, adhesion, and the like. The amount of resin included in the conductive resin layer is preferably about 25 vol % to about 65 vol % of the total volume of the conductive resin.

Furthermore, the conductive resin layer preferably includes a curing agent in addition to the thermosetting resin. In a case of using epoxy resin as the base resin, various well-known compounds, such as phenolic, amine, acid anhydride, and imidazole compounds, can be used as the curing agent.

The conductive resin layer includes a thermosetting resin and is thus more flexible than conductive layers formed by firing a plating film or conductive paste, for example. Therefore, even if the ceramic electronic component is subjected to physical impact or thermal cycling-induced impact, the conductive resin layer functions as a buffer layer, making it possible to reduce cracks in the ceramic electronic component.

Ag, Cu, Ni, or an alloy thereof can be used as metal powder included in the conductive resin layer. Cu or Ni metal powder may have an Ag-coated surface. The Cu metal powder may also have its surface subjected to antioxidation treatment.

The reason for using Ag metal powder as the conductive metal is that Ag has the lowest resistivity of all metals, making it suitable as an electrode material, and that Ag, being a noble metal, does not oxidize and is highly resistant. The reason for using Ag-coated metal is that it allows for the use of a cheaper base metal while maintaining the above-mentioned characteristics of Ag.

The metal powder included in the conductive resin layer preferably accounts for about 35 vol % to about 75 vol % of the total volume of the conductive resin, for example.

The shape of the metal powder included in the conductive resin layer is not particularly limited. The metal powder may have a spherical shape, flat shape or the like. The average particle size of the metal powder included in the conductive resin layer is not particularly limited, but may be about 0.3 μm to about 10 μm, for example.

The metal powder included in the conductive resin layer is mainly responsible for the electrical conductivity of the conductive resin layer. Specifically, contact between the metal powder particles forms energizing paths within the conductive resin layer.

The first plating layer 416 covers the first underlying electrode 415. The second plating layer 426 is disposed so as to cover the second underlying electrode 425. The conductive resin layers may be disposed between the first plating layer 416 and the first underlying electrode 415 and between the second plating layer 426 and the second underlying electrode 425.

The first plating layer 416 and the second plating layer 426 preferably include at least one type of metal selected from the group consisting of Cu, Ni, Sn, Pb, Au, Ag, Pd, Bi, and Zn, for example, or an alloy including these metals. For example, if the inner electrode 30 is formed using Ni, a direct plating layer is preferably formed using Cu, which has good bondability with Ni.

The first plating layer 416 and the second plating layer 426 preferably have a thickness per layer of about 1.0 μm to about 15 μm, for example. The first plating layer 416 and the second plating layer 426 preferably contain no glass components. The proportion of metal included per unit volume in each of the first plating layer 416 and the second plating layer 426 is preferably more than or equal to about 99% by volume, for example.

Both electrolytic plating and electroless plating can be used for plating. However, electroless plating requires pretreatment using a catalyst or the like to improve plating deposition rate, leading to a disadvantage of complicating the process. Therefore, it is usually preferable to adopt electrolytic plating. Barrel plating is preferably used as a plating method. If necessary, an upper plating electrode may be similarly formed on the surface of a lower plating electrode.

The first plating layer 416 and the second plating layer 426 on the first underlying electrode 415 and the second underlying electrode 425, respectively, include at least one of Cu, Ni, Ag, Pd, Ag—Pd alloy, or Au, or the like, for example.

The first plating layer 416 and the second plating layer 426 can each include a plurality of layers. In the case of a plurality of layers, a two-layer structure including Ni plating and Sn plating, for example, is preferable. The Ni plating layer can reduce or prevent the underlying electrode from being eroded by solder upon mounting of ceramic electronic components. The Sn plating layer can improve solder wettability upon mounting of ceramic electronic components, thus facilitating the mounting. The thickness of each plating layer is preferably about 1.0 μm to about 15 μm, for example.

The multilayer ceramic capacitor 1 has been described above, in which the first underlying electrode 415 is on the third surface P3, the second underlying electrode 425 is on the fourth surface P4, and the first inner electrode 31 and the second inner electrode 32 are connected to the first underlying electrode 415 and the second underlying electrode 425, respectively. However, the multilayer ceramic capacitors of example embodiments of the present invention are not limited to such a configuration. For example, the second underlying electrode 425 may be on one or more of the third surface P3, fifth surface P5, and sixth surface P6, rather than on the fourth surface P4 facing the third surface P3 in the first direction D1, and the second inner electrode 32 may be connected to the second underlying electrode 425 thus disposed. Furthermore, the first inner electrode 31 does not necessarily have to face the second inner electrode 32 in the lamination direction T.

When the second underlying electrode 425 is on the third surface P3, it is preferable that the third surface P3 be the mounting surface side. Furthermore, in this case, the second inner electrode 32 is exposed on the third surface P3 and is not connected to the first underlying electrode 415.

When the second underlying electrode 425 is on the fifth surface P5, the second inner electrode 32 is exposed on the fifth surface P5 and is not connected to the first underlying electrode 415.

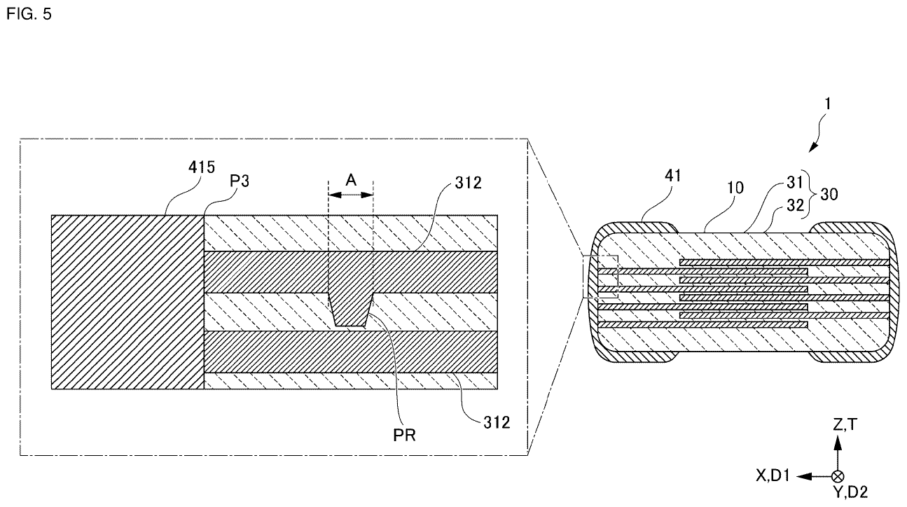

The first inner electrode 31 connected to the first underlying electrode 415 includes a protrusion PR that protrudes into the inner dielectric layer 20i at the portion where the first inner electrodes face each other across the inner dielectric layer 20i, that is, in the extended portion 312 of the first inner electrode 31 in the first end margin portion LG1 as shown in FIG. 5 in this example embodiment. The protrusion PR includes the metal component included in the first underlying electrode 415.

By thus providing the extended portion 312 of the first inner electrode 31 with the protrusion PR including the metal component included in the first underlying electrode 415, generation of cracks in the multilayer body 10 can be reduced or prevented even if the metal component included in the first underlying electrode 415 diffuses excessively.

The protrusion PR is preferably located within about 5 μm of the third surface P3. This makes it possible to effectively reduce or prevent the diffusion and expansion of the metal component included in the first underlying electrode 415 toward the inner electrode 30, thus reducing the generation of cracks in the multilayer body 10.

The maximum dimension A of the protrusion PR in the first direction D1 is, for example, preferably about 0.5 times to about 1.5 times the thickness of the first inner electrode 31 in the lamination direction T.

This can achieve the effect of both reducing or preventing the generation of cracks (setting an upper limit on the thin side) and ensuring ESR to maintain bondability (setting an upper limit on the thick side). On the other hand, if the thickness is large, in-plane inner electrode continuity decreases due to the supply from the inner electrode.

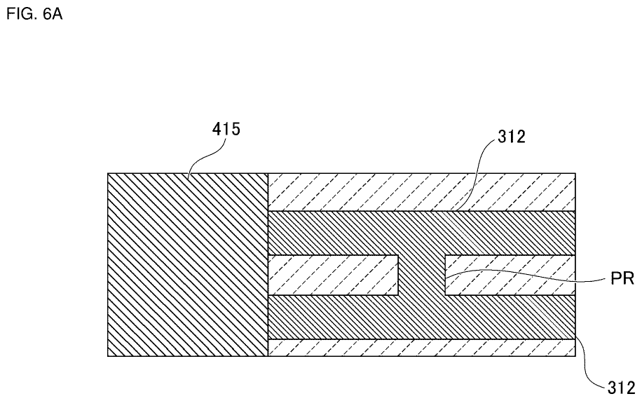

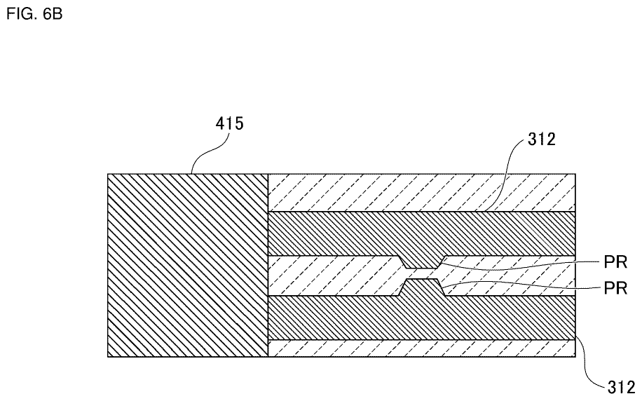

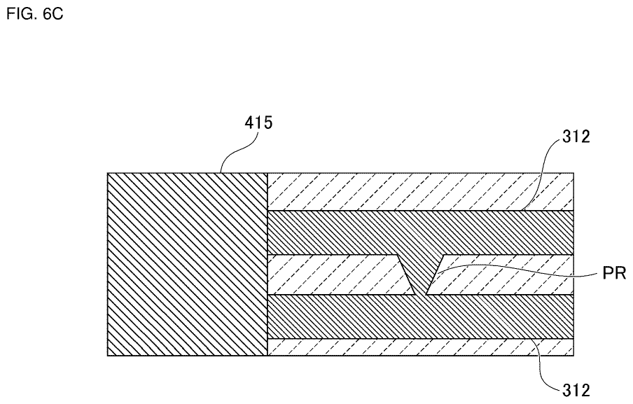

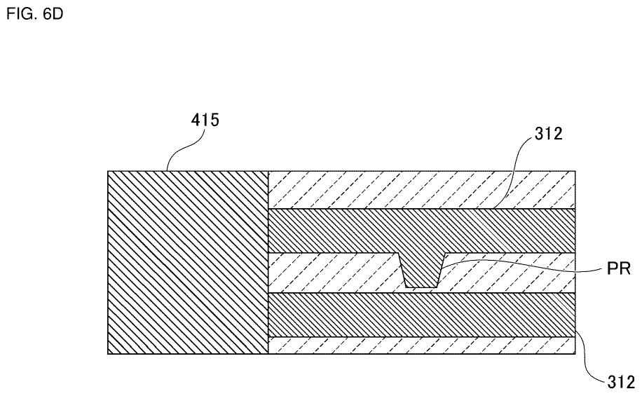

FIGS. 6A to 6D show example embodiments of the protrusion PR provided in the extended portion 312 of the first inner electrode 31. FIGS. 6C and 6D show example embodiments of a protrusion PR that protrudes into the inner dielectric layer 20i from one of the extended portions 312 of two first inner electrodes 31 facing each other across the inner dielectric layer 20i. FIG. 6B shows an example embodiment of protrusions PR protruding into the inner dielectric layer 20i from both of the extended portions 312 of two first inner electrodes 31 facing each other across the inner dielectric layer 20i. FIGS. 6A and 6C each show a protrusion PR connecting the two first inner electrodes 31.

It is preferable that the protrusions PR be provided in about 10% or more of the total number of first inner electrodes 31 in an observation field showing ten or more first inner electrodes 31. For example, if the total number of first inner electrodes 31 in the observation field is 20, it is preferable that protrusions PR be provided in two or more first inner electrodes 31. It is also preferable that protrusions PR be provided in six or more first inner electrodes 31 when the total number of first inner electrodes 31 is 58, and in five or more first inner electrodes 31 when the total number is 54, for example. This can provide a force that effectively resists a stress concentration portion (internal stress) of the multilayer body 10, thus achieving the effect of reducing or preventing the generation of cracks.

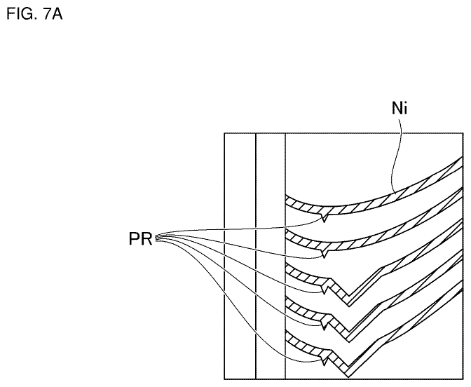

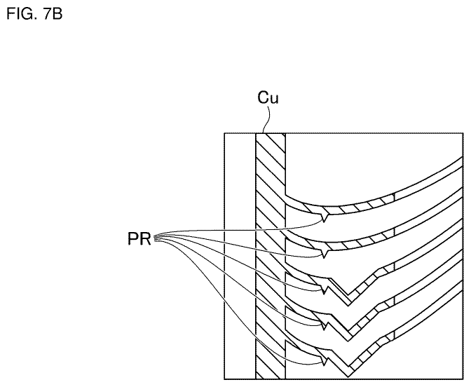

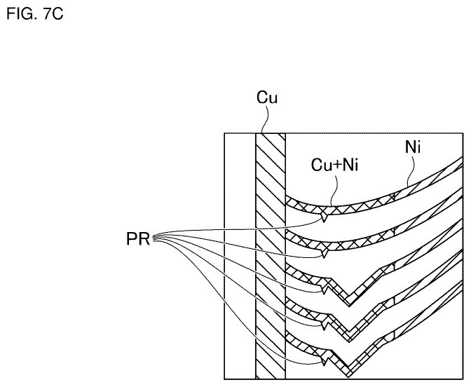

FIGS. 7A to 7C show an LT cross-section, including the lamination direction T and the first direction D1, of the multilayer ceramic capacitor 1 in which the inner electrode 30 mainly includes Ni and the first underlying electrode 415 and the second underlying electrode 425 mainly include Cu, as observed using an SEM-WDX. FIG. 7A shows distribution of Ni. FIG. 7B shows distribution of Cu. FIG. 7C shows distribution of Cu and Ni.

The dielectric layer 20 mainly includes BaTiO₃.

As shown in FIGS. 7A to 7C, the first inner electrode 31 connected to the first underlying electrode 415 preferably has a curved portion on the surface where the first inner electrodes face each other across the dielectric layer, that is, the extended portion 312, and a protrusion PR protruding substantially perpendicularly from the surface of the curved portion.

This results in a structure that is effective in reducing or preventing cracks in the multilayer body 10, as the stress is applied in the same direction upon diffusion and expansion from the first underlying electrode 415 to the inner electrode.

Furthermore, when viewed in the LT cross-section including the lamination direction T and the first direction D1, the first inner electrode 31 connected to the first underlying electrode 415 preferably has a bent portion at the portion where the first inner electrodes face each other across the dielectric layer, that is, in the extended portion 312, and a protrusion PR on the third surface P3 side of this bent portion.

This results in a structure that effectively resists stress concentration due to diffusion and expansion at the bent portion, making it possible to reduce or prevent the generation of cracks in the multilayer body.

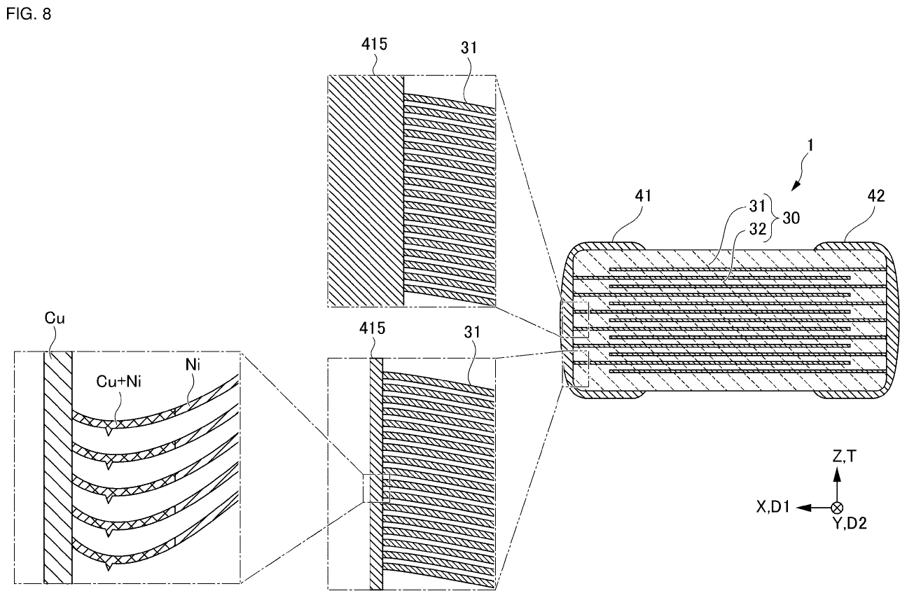

When the distance between the inner electrode 30 located closest to the first surface P1 and the inner electrode 30 located closest to the second surface P2 is divided into thirds in the lamination direction T, and the inner layer portion 100 is divided into a first surface P1 side region, a central region, and a second surface P2 side region, it is preferable that more protrusions PR be disposed in the first surface side region and the second surface side region than in the central region (FIG. 8).

The first underlying electrode 415 is prone to discontinuity since its film thickness is thinner in the first surface side region and the second surface side region. However, when the protrusions PR connect the first inner electrodes adjacent to each other in the lamination direction T, as shown in FIG. 6A, the probability of electrical connection increases, thus reducing or preventing an increase in ESR.

The metal ratio of the region of the first underlying electrode 415 connected to the first inner electrode 31 on which the protrusion PR is formed, within about 5 μm of an area immediately above the first inner electrode 31, is preferably higher than the metal ratio of the region of the first underlying electrode 415 connected to the first inner electrode 31 on which no protrusion PR is formed, within about 5 μm of an area immediately above the first inner electrode 31, for example.

This increases the connected metal area, thus achieving the effect of reducing or preventing an increase in ESR.

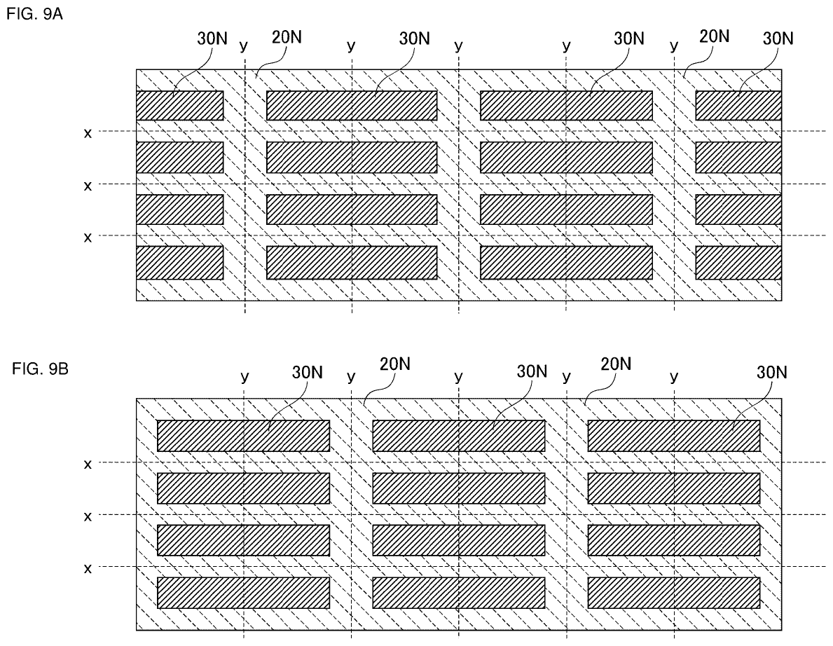

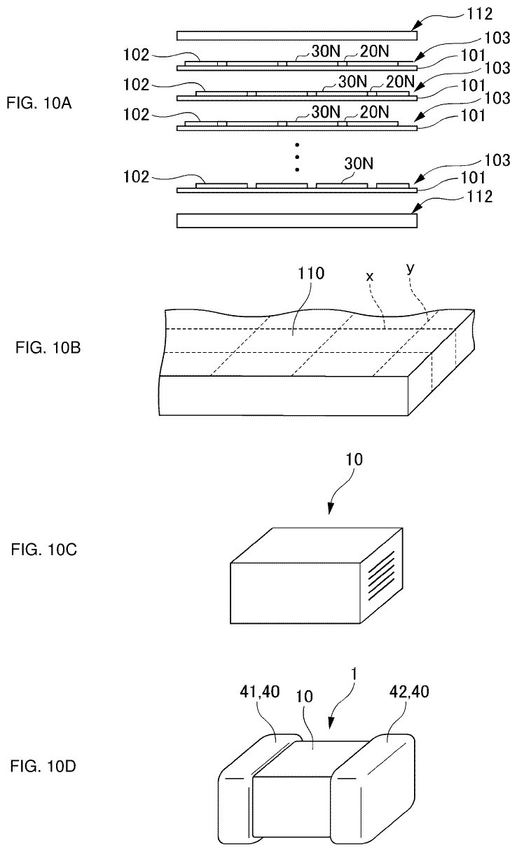

With reference to FIGS. 9 and 10, description will be given of an example of a method for manufacturing the multilayer ceramic capacitor 1 described above. First, a dielectric sheet for the dielectric layer 20 and a conductive paste for the inner electrode 30 are prepared. The dielectric sheet and the conductive paste including binder and a solvent. Known materials can be used as the binder and the solvent.

Next, an inner electrode pattern is formed on the dielectric sheet by printing the conductive paste on the dielectric sheet in a predetermined pattern, for example. As a method for forming the inner electrode pattern, screen printing, gravure printing or the like can be used.

A dielectric sheet with two inner electrode patterns, as shown in FIGS. 9A and 9B, can be created. Coated portions 30N coated with the conductive paste are aligned at intervals in the first direction D1 and the second direction D2. A ceramic paste may be applied between the adjacent coated portions 30N to form height adjustment portions 20N. The height adjustment portion 20N is coated with approximately the same thickness as that of the conductive paste in the coated portion 30N, eliminating steps caused by the coated portions 30N and smoothing the surface of the material sheet. As shown in FIGS. 9A and 9B, the two inner electrode patterns are printed while being shifted in the first direction D1. As described later, the inner layer portion 100 can be formed by alternately laminating the dielectric sheets with the two inner electrode patterns in the lamination direction T and cutting them in the lamination direction T along cutting lines x and y.

The coated portion 30N coated with the conductive paste defines the first inner electrode 31 and the second inner electrode 32 in the fired multilayer body 10. In the multilayer body 10, the height adjustment portion 20N defines the dielectric layer 20z disposed to eliminate steps at both ends of the inner electrode 30 in the first direction D1 and the dielectric layer 20w disposed to eliminate steps at both ends of the inner electrode 30 in the second direction D2.

Next, as shown in FIG. 10A, a plurality of material sheets 103 are laminated with conductive patterns 102 facing the same direction and shifted by half pitch in the longitudinal direction between the adjacent material sheets 103. Furthermore, outer layer ceramic green sheets 112 to be outer layer portions 200 are laminated on both sides of the plurality of laminated material sheets 103. A multilayer sheet is thus prepared. In a case of disposing dummy electrodes in the outer layer portions 200, outer layer dielectric sheets printed with dummy electrode patterns are laminated.

Next, the multilayer sheet is pressed in the lamination direction T using an isostatic press or the like to create a multilayer block. Then, the multilayer block is cut to a predetermined size in the lamination direction T along cutting lines x and y shown in FIG. 10B, thereby cutting out multilayer body chips 10T.

According to the above process, the side margin portions WG can be formed simultaneously with the formation of the multilayer body 10. Alternatively, the multilayer body 10 may be formed by first cutting out the inner layer portion 100 from a mother block, with the end portions of the inner electrodes 30 in the second direction D2 exposed on both sides, and then attaching the side margin portions WG to both sides of the inner layer portion 100 so as to cover the exposed end portions of the inner electrodes 30. In this event, the side margin portions WG to be attached can be made of the same dielectric ceramic material as the inner dielectric layer 20i. Alternatively, the side margin portions WG may be formed by applying a ceramic paste to both sides of the inner layer portion 100.

The multilayer body chip 10T thus formed is fired to produce the multilayer body 10 (FIG. 10C). The firing temperature is preferably about 900 °C to about 1400 °C, for example, depending on the materials of the dielectric and inner electrodes.

The fired multilayer body 10 is polished by sandblasting on the third surface P3 to form gaps (cavities) between the laminated first inner electrodes 31. As described below, the metal components of the first inner electrodes 31 flow into these gaps (cavities), thus forming protrusions PR.

Note that the method for forming the protrusions PR is not limited to polishing by sandblasting to form gaps (cavities) between the laminated first inner electrodes 31. For example, through-holes or recesses may be formed in the dielectric sheet before application of the conductive paste, and then the conductive paste may be applied thereto. By applying the conductive paste to such a dielectric sheet, a material sheet is formed with some of the conductive paste filled in the through-holes or recesses.

By arranging the through-holes or recesses in the dielectric sheet at positions corresponding to the vicinities of the cutting lines y approximately in the center of the conductive paste coated portions 30N, as shown in FIGS. 9A and 9B, the multilayer body 10 can be formed having the protrusions PR in the extended portions 311 of the first inner electrodes 31.

Next, using a dip method, the third surface P3 of the multilayer body 10 is immersed in the conductive paste as the electrode material for underlying electrodes to apply the conductive paste for the first underlying electrode 415 to the third surface P3. Similarly, using the dip method, the fourth surface P4 of the multilayer body 10 is immersed in the conductive paste as the electrode material for underlying electrodes to apply the conductive paste for the second underlying electrode 425 to the fourth surface P4.

Thereafter, these conductive pastes are fired to form the first underlying electrode 415 and the second underlying electrode 425, which are fired layers. The firing temperature is preferably about 600 °C to about 900 °C, for example.

Firing causes metal components such as Ni included in the first inner electrodes 31 to migrate into the cavities between the first inner electrodes 31, forming the protrusions PR. However, if the conductive paste for the underlying electrodes includes a glass component, the metal components flow into the cavities along with the flow of the glass component, facilitating the formation of the protrusions PR.

Then, a first plating layer 416 is formed on the surface of the first underlying electrode 415 to form a first outer electrode 41, and a second plating layer 426 is formed on the surface of the second underlying electrode 425 to form a second outer electrode 42. Through these steps, the multilayer ceramic capacitor 1 shown in FIG. 10D is obtained.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of dielectric layers and a plurality of inner electrodes laminated in a lamination direction, and including a first main surface and a second main surface facing each other in the lamination direction, a third surface and a fourth surface facing each other in a first direction intersecting with the lamination direction, and a fifth surface and a sixth surface facing each other in a second direction intersecting with the lamination direction and the first direction; and
a first underlying electrode and a second underlying electrode on a surface of the multilayer body; wherein
the first underlying electrode is on the third surface;
the inner electrode connected to the first underlying electrode includes a protrusion that protrudes into the dielectric layer on a surface where the inner electrodes face each other across the dielectric layer; and
the protrusion includes a metal included in the first underlying electrode.

2. The multilayer ceramic capacitor according to claim 1, wherein the protrusion is located within about 5 μm of the third surface.

3. The multilayer ceramic capacitor according to claim 1, wherein a maximum dimension of the protrusion in the first direction is about 0.5 times to about 1.5 times a thickness in the lamination direction of the inner electrode connected to the first underlying electrode.

4. The multilayer ceramic capacitor according to claim 1, wherein, when viewed in a cross-section including the lamination direction and the first direction, the inner electrode connected to the first underlying electrode includes a curved portion where the inner electrodes face each other across the dielectric layer, and includes the protrusion that protrudes substantially perpendicularly from a surface of the curved portion.

5. The multilayer ceramic capacitor according to claim 1, wherein, when viewed in a cross-section including the lamination direction and the first direction, the inner electrode connected to the first underlying electrode includes a bent portion where the inner electrodes face each other across the dielectric layer, and includes the protrusion located closer to the third surface than the bent portion.

6. The multilayer ceramic capacitor according to claim 1, wherein the first underlying electrode and the second underlying electrode are baked layers.

7. The multilayer ceramic capacitor according to claim 6, wherein each of the baked layers has a thickness of about 0.1 μm to about 200 μm.

8. The multilayer ceramic capacitor according to claim 6, wherein each of the baked layers includes a plurality of layers.

9. The multilayer ceramic capacitor according to claim 1, wherein each of the first underlying electrode and the second underlying electrode includes at least one of Cu, Ni, Ag, Pd, Ag—Pd alloy, or Au.

10. The multilayer ceramic capacitor according to claim 1, wherein each of the first underlying electrode and the second underlying electrode includes at least one of B, Si, Ba, Mg, Al, or Li.

11. The multilayer ceramic capacitor according to claim 1, wherein the protrusion is provided in about 10% or more of the plurality of internal electrodes.

12. The multilayer ceramic capacitor according to claim 1, wherein the protrusion is provided in two or more of the plurality of internal electrodes, and more of the protrusions are located in side regions than in a central region of the multilayer body.

13. The multilayer ceramic capacitor according to claim 1, wherein a metal ratio of a region of the first underlying electrode connected to one of the plurality of inner electrodes that includes the protrusion is higher than a metal ratio of a region of the first underlying electrode connected to one of the plurality of inner electrodes that does not include the protrusion.

14. A multilayer ceramic capacitor comprising:
a multilayer body including a plurality of dielectric layers and a plurality of inner electrodes laminated in a lamination direction, and including a first main surface and a second main surface facing each other in the lamination direction, a third surface and a fourth surface facing each other in a first direction intersecting with the lamination direction, and a fifth surface and a sixth surface facing each other in a second direction intersecting with the lamination direction and the first direction; and
a first underlying electrode and a second underlying electrode on a surface of the multilayer body; wherein
the first underlying electrode is on the third surface;
the inner electrode connected to the first underlying electrode includes a protrusion that protrudes into the dielectric layer on a surface where the inner electrodes face each other across the dielectric layer;
the protrusion includes a metal included in the first underlying electrode; and
the multilayer ceramic capacitor has a dimension in the first direction of about 0.10 mm to about 0.16 mm, a dimension in the second direction of about 0.05 mm to about 0.10 mm, and a dimension in the lamination direction of about 0.05 mm to about 0.10 mm.

15. The multilayer ceramic capacitor according to Claim 14, wherein the protrusion is located within about 5 μm of the third surface.

16. The multilayer ceramic capacitor according to Claim 14, wherein a maximum dimension of the protrusion in the first direction is about 0.5 times to about 1.5 times a thickness in the lamination direction of the inner electrode connected to the first underlying electrode.

17. The multilayer ceramic capacitor according to Claim 14, wherein, when viewed in a cross-section including the lamination direction and the first direction, the inner electrode connected to the first underlying electrode includes a curved portion where the inner electrodes face each other across the dielectric layer, and includes the protrusion that protrudes substantially perpendicularly from a surface of the curved portion.

18. The multilayer ceramic capacitor according to Claim 14, wherein, when viewed in a cross-section including the lamination direction and the first direction, the inner electrode connected to the first underlying electrode includes a bent portion where the inner electrodes face each other across the dielectric layer, and includes the protrusion located closer to the third surface than the bent portion.
